(19) United States
(12) Patent Application Publication
(10) Pub. No.: US 2005/0109151 A1
(43) Pub. Date: May 26, 2005

(54) Adjustable armrests on handlebar

(76) Inventors: Douglas Chiang, Dali City (TW); David Michael Anthony, Dali City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/722,239

(22) Filed: Nov. 25, 2003

(51) Int. Cl. B62K 21/12

(52) U.S. Cl. 74/551.1

(57) ABSTRACT

A handlebar assembly for bicycle includes a handlebar composed of a central fitting and two wings which are integrally connected to two ends of the central fitting. Two grips are connected to the two wings respectively. Two armrests each have a recess defined in an outer periphery thereof and the central fitting of the handlebar is engaged with the recess of each of the two armrests. Two C-shaped members are mounted to the central fitting and two bolts extend through two ends of each of the C-shaped members and are connected to the two armrests. The two armrests are pivotable about the central fitting when needed.

### FIELD OF THE INVENTION

The present invention relates to a bicycle handlebar which has two armrests which is pivotably connected to the handlebar so as to be fit different needs of users.

### BACKGROUND OF THE INVENTION

A conventional racing bicycle handlebar assembly 1 is shown in FIG. 4 and generally includes a handlebar composed of a central fitting 4 and two wings 2 connected to two ends of the central fitting 4. Tow grips 3 are connected to two wings 2 so that the rider can hold the grips 3 while riding the bicycle. Two tubes 5 extend from the central fitting 4 and two armrests 6 are inserted in the two tubes 5. The armrests 6 allow the rider to rest his or her arms during taxing. Nevertheless, the two armrests 6 are fixed to the tubes 5 and cannot be adjustable. In other words, if the rider is a short rider, then he or she has to move forward to let the arms to be rested on the armrests 6. This is not comfortable for the shorter riders. For a tall rider, this is also inconvenient because he or she needs to move backward.

The present invention intends to provide adjustable armrests which are pivotably connected to the central fitting of the handlebar so as to be adjusted according to the needs of the riders.

### SUMMARY OF THE INVENTION

The present invention relates to a handlebar assembly for bicycle and comprises a central fitting and two wings integrally connected to two ends of the central fitting. Two grips are connected to the two wings respectively. Two armrests each have a recess defined in an outer periphery thereof so that the central fitting of the handlebar is rotatably engaged with the recess of each of the two armrests.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the handlebar assembly of the present invention;

FIG. 2 is a perspective view to show that the handlebar assembly of the present invention is connected to a handlebar stem,

FIG. 3 shows that the armrests are pivotable about the handlebar, and

FIG. 4 shows a conventional handlebar assembly.

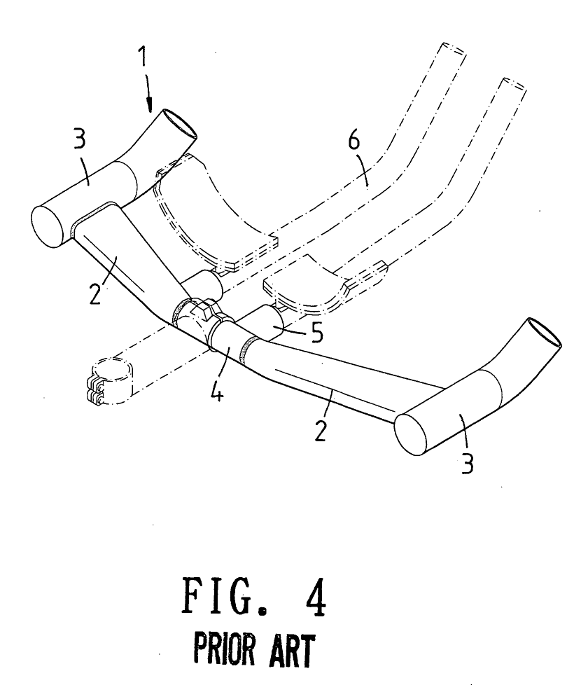

### DETAILED DESCRIPTION OF THE PREFERRED EMBODIMENT

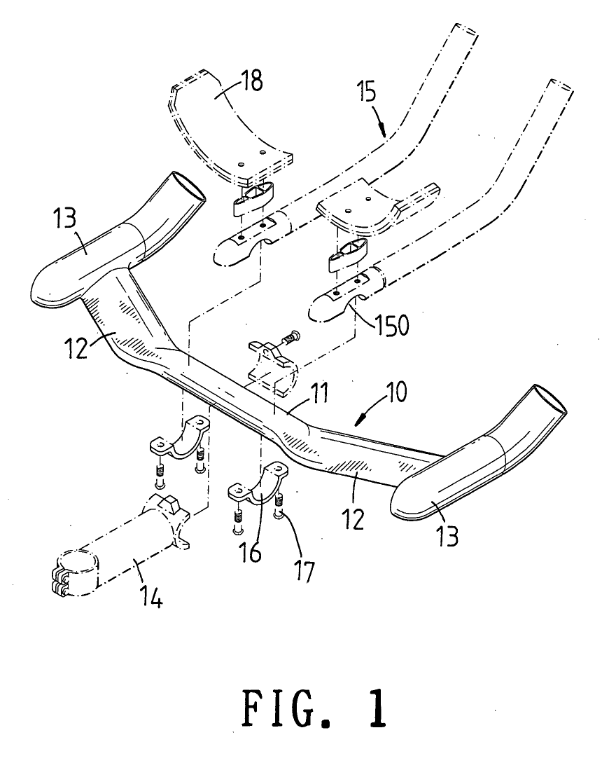

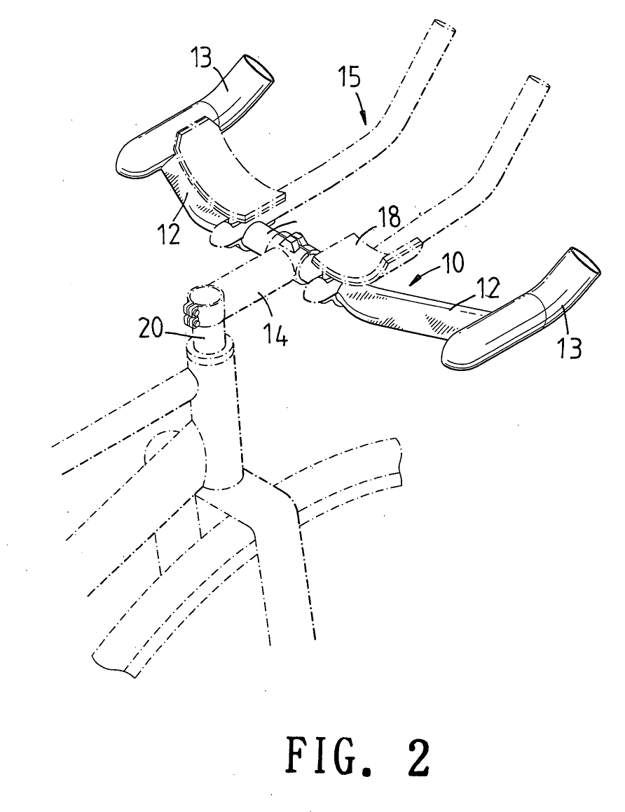

Referring to FIGS. 1 and 2, the handlebar assembly of the present invention comprises a handlebar 10 composed of a central fitting 11 and two wings 12 are integrally connected to two ends of the central fitting 11. Two grips 13 are connected to the two wings 12 respectively as the conventional handlebar assembly. Two armrests 15 each have a recess 150 defined in an outer periphery thereof and the central fitting 11 of the handlebar 10 is engaged with the recess 150 of each of the two armrests 15. Two C-shaped members 16 are mounted to the central fitting 11 from an underside of the central fitting 11 and two bolts 17 extend through two ends of each of the C-shaped members 16 and the two armrests 15. Two elbow pads 18 are connected to the two bolts 17 extending through the two armrests 15. A handlebar stem 14 has one end connected to the steerer tube 20 and the other end of the handlebar stem 14 is fixed to the central fitting 11.

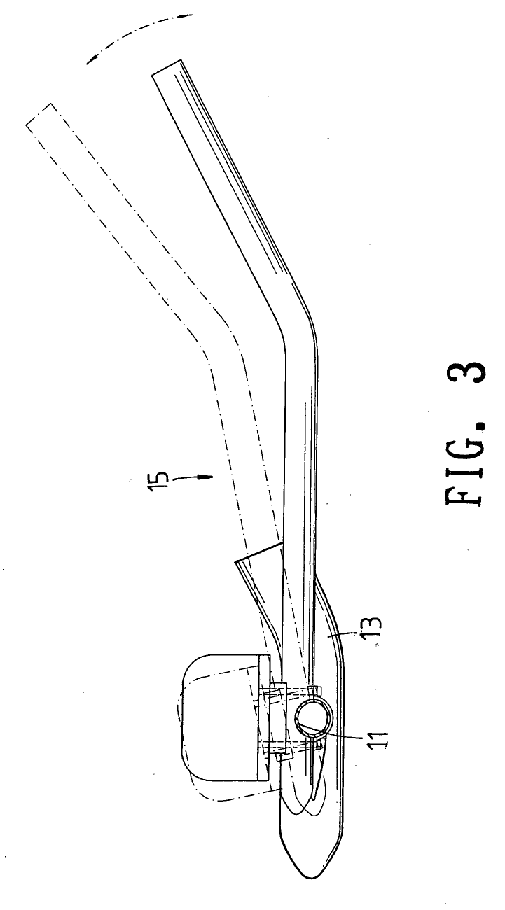

As shown in FIG. 3, the armrests 15 can be pivotable relative to the central fitting 11 by loosening the two bolts 17 and set a desired angle by tightening the bolts 17 again, so that the riders can comfortably rest their arms on the armrests 15.

While we have shown and described the embodiment in accordance with the present invention, it should be clear to those skilled in the art that further embodiments may be made without departing from the scope of the present invention.

1. A handlebar assembly for bicycle, comprising:
a handlebar composed of a central fitting and two wings integrally connected to two ends of the central fitting, two grips connected to the two wings respectively, and
two armrests each having a recess defined in an outer periphery thereof and the central fitting of the handlebar being engaged with the recess of each of the two armrests.

2. The handlebar assembly as claimed in claim 1 further comprising two C-shaped members which are mounted to the central fitting and two bolts extend through two ends of each of the C-shaped members and are connected to the two armrests.
